(19) United States
(12) Patent Application Publication
(10) Pub. No.: US 2018/0180949 A1
(43) Pub. Date: Jun. 28, 2018

(54) LIQUID CRYSTAL DISPLAY PANEL AND LIQUID CRYSTAL DISPLAY DEVICE

(71) Applicant: WUHAN CHINA STAR OPTOELECTRONICS TECHNOLOGY CO., LTD., Wuhan, Hubei (CN)

(72) Inventor: Biao PAN, Wuhan, Hubei (CN)

(21) Appl. No.: 15/313,556

(22) PCT Filed: Aug. 19, 2016
(86) PCT No.: PCT/CN2016/096056

§ 371 Date: Nov. 23, 2016

(30) Foreign Application Priority Data
Jul. 19, 2016 (CN) 201610571374.8

(51) Int. Cl. G02F 1/1343; G02F 1/1335

(52) U.S. Cl. CPC G02F 1/134309; G02F 1/133512; G02F 2201/52; G02F 2201/123; G02F 2001/134345

(57) ABSTRACT

The present invention provides a liquid crystal display panel and a liquid crystal display device including data lines, scan lines, and pixel units disposed among the data lines and the scan lines. Each of the pixel units includes a plurality of red pixel units, a plurality of green pixel units, and a plurality of blue pixel units. Each of the red pixel units includes a red sub pixel unit and at least one first white sub pixel unit. Each of the green pixel units includes a green sub pixel unit and at least one second white sub pixel unit. Each of the blue pixel units includes a blue sub pixel unit and at least one third white sub pixel unit.

### BACKGROUND

### Field of the Invention

The present invention relates to a liquid crystal display field, and more particularly to a gate drive circuit and a liquid crystal display device.

### Description of Prior Art

RGBW liquid crystal display technology is a sub pixel imaging technology in which white sub pixels are added to traditional red, green, and blue (RGB) sub pixels. Then, the corresponding sub pixel imaging technology is applied to arrange the above-mentioned sub pixels properly. Since resolutions of liquid crystal display screens are higher and higher and pixels are finer and finer, aperture ratios of liquid crystal pixels are decreased, thereby decreasing light transmittances. Accordingly, RGBW liquid crystal screens are issued to solve a problem that a light transmittance is too low in a white image of a liquid crystal display screen.

However, since the white sub pixels are add in a RGBW liquid crystal screen, a technical problem that a pure color is deteriorating occurs. For example, relative proportions of the red, green, and blue sub pixels are decreased when the white sub pixels are added. As such, a color brightness of a whole image is low when a red, green and blue image is displayed.

When a red image is displayed by utilizing the red sub pixels and the white sub pixels, color saturation (NTSC) of the red image is decreased seriously. As such, display quality of a liquid crystal display panel is worse.

Consequently, there is a need to provide a liquid crystal display panel and a liquid crystal display device to solve the problems which exist in the prior art.

### SUMMARY OF THE INVENTION

An objective of the present invention is to provide a liquid crystal display panel and a liquid crystal display device capable of increasing brightness of a displayed image and display quality of the displayed image, so as to solve the technical problems that the brightness of the displayed image is low and the display quality is worse in the conventional liquid crystal display panel and the liquid crystal display device.

An embodiment of the present invention provides a liquid crystal display panel, comprising data lines, scan lines, and pixel units disposed among the data lines and the scan lines,

Each of the pixel units comprises:

A plurality of red pixel units each comprising a red sub pixel unit and at least one first white sub pixel unit which are driven by a same red pixel electrode;

A plurality of green pixel units each comprising a green sub pixel unit and at least one second white sub pixel unit which are driven by a same green pixel electrode; and

A plurality of blue pixel units each comprising a blue sub pixel unit and at least one third white sub pixel unit which are driven by a same blue pixel electrode,

A black matrix is disposed between the red pixel unit and an adjacent green pixel unit; a black matrix is disposed between the green pixel unit and an adjacent blue pixel unit; a black matrix is disposed between the blue pixel unit and an adjacent red pixel unit;

An area of the red pixel unit, an area of the green pixel unit, and an area of the blue pixel unit are the same;

Areas of at least two of the first white sub pixel unit, the second white sub pixel unit, and the third white sub pixel unit are different.

In the liquid crystal display panel of the present invention, the first white sub pixel unit is disposed at one side of a corresponding red sub pixel unit; the second white sub pixel unit is disposed at one side of a corresponding green sub pixel unit; the third white sub pixel unit is disposed at one side of a corresponding blue sub pixel unit.

In the liquid crystal display panel of the present invention, a black matrix is disposed between the first white sub pixel unit and the red sub pixel unit; a black matrix is disposed between the second white sub pixel unit and the green sub pixel unit; a black matrix is disposed between the third white sub pixel unit and the blue sub pixel unit.

In the liquid crystal display panel of the present invention, the first white sub pixel units are disposed at two sides of a corresponding red sub pixel unit; the second white sub pixel units are disposed at two side of a corresponding green sub pixel unit; the third white sub pixel units are disposed at two side of a corresponding blue sub pixel unit.

In the liquid crystal display panel of the present invention, areas of the first white sub pixel units at the two sides of the red sub pixel unit are the same; areas of the second white sub pixel units at the two sides of the green sub pixel unit are the same; areas of the third white sub pixel units at the two sides of the blue sub pixel unit are the same.

In the liquid crystal display panel of the present invention, the first white sub pixel units are disposed around a corresponding red sub pixel unit; the second white sub pixel units are disposed around a corresponding green sub pixel unit; the third white sub pixel units are disposed around a corresponding blue sub pixel unit.

An embodiment of the present invention provides a liquid crystal display panel, comprising data lines, scan lines, and pixel units disposed among the data lines and the scan lines,

Each of the pixel units comprises:

A plurality of red pixel units each comprising a red sub pixel unit and at least one first white sub pixel unit which are driven by a same red pixel electrode;

A plurality of green pixel units each comprising a green sub pixel unit and at least one second white sub pixel unit which are driven by a same green pixel electrode; and

A plurality of blue pixel units each comprising a blue sub pixel unit and at least one third white sub pixel unit which are driven by a same blue pixel electrode.

In the liquid crystal display panel of the present invention, the first white sub pixel unit is disposed at one side of a corresponding red sub pixel unit;

The second white sub pixel unit is disposed at one side of a corresponding green sub pixel unit;

The third white sub pixel unit is disposed at one side of a corresponding blue sub pixel unit.

In the liquid crystal display panel of the present invention, a black matrix is disposed between the first white sub pixel unit and the red sub pixel unit;

A black matrix is disposed between the second white sub pixel unit and the green sub pixel unit;

A black matrix is disposed between the third white sub pixel unit and the blue sub pixel unit.

In the liquid crystal display panel of the present invention, the first white sub pixel units are disposed at two sides of a corresponding red sub pixel unit;

The second white sub pixel units are disposed at two side of a corresponding green sub pixel unit;

The third white sub pixel units are disposed at two side of a corresponding blue sub pixel unit.

In the liquid crystal display panel of the present invention, areas of the first white sub pixel units at the two sides of the red sub pixel unit are the same;

Areas of the second white sub pixel units at the two sides of the green sub pixel unit are the same;

Areas of the third white sub pixel units at the two sides of the blue sub pixel unit are the same.

In the liquid crystal display panel of the present invention, the first white sub pixel units are disposed around a corresponding red sub pixel unit;

The second white sub pixel units are disposed around a corresponding green sub pixel unit;

The third white sub pixel units are disposed around a corresponding blue sub pixel unit.

In the liquid crystal display panel of the present invention, a black matrix is disposed between the red pixel unit and an adjacent green pixel unit; a black matrix is disposed between the green pixel unit and an adjacent blue pixel unit; a black matrix is disposed between the blue pixel unit and an adjacent red pixel unit.

In the liquid crystal display panel of the present invention, an area of the red pixel unit, an area of the green pixel unit, and an area of the blue pixel unit are the same.

In the liquid crystal display panel of the present invention, areas of at least two of the first white sub pixel unit, the second white sub pixel unit, and the third white sub pixel unit are different.

An embodiment of the present invention further provides a liquid crystal display device, comprising a liquid crystal display panel and a backlight module, the liquid crystal display panel comprising data lines, scan lines, and pixel units disposed among the data lines and the scan lines,

Each of the pixel units comprises:

A plurality of red pixel units each comprising a red sub pixel unit and at least one first white sub pixel unit which are driven by a same red pixel electrode;

A plurality of green pixel units each comprising a green sub pixel unit and at least one second white sub pixel unit which are driven by a same green pixel electrode; and

A plurality of blue pixel units each comprising a blue sub pixel unit and at least one third white sub pixel unit which are driven by a same blue pixel electrode.

In the liquid crystal display device of the present invention, the first white sub pixel unit is disposed at one side of a corresponding red sub pixel unit; the second white sub pixel unit is disposed at one side of a corresponding green sub pixel unit; the third white sub pixel unit is disposed at one side of a corresponding blue sub pixel unit.

In the liquid crystal display device of the present invention, a black matrix is disposed between the first white sub pixel unit and the red sub pixel unit; a black matrix is disposed between the second white sub pixel unit and the green sub pixel unit; a black matrix is disposed between the third white sub pixel unit and the blue sub pixel unit.

In the liquid crystal display device of the present invention, the first white sub pixel units are disposed at two sides of a corresponding red sub pixel unit; the second white sub pixel units are disposed at two side of a corresponding green sub pixel unit; the third white sub pixel units are disposed at two side of a corresponding blue sub pixel unit.

In the liquid crystal display device of the present invention, the first white sub pixel units are disposed around a corresponding red sub pixel unit; the second white sub pixel units are disposed around a corresponding green sub pixel unit; the third white sub pixel units are disposed around a corresponding blue sub pixel unit.

Compared with the conventional liquid crystal display panel and the liquid crystal display device, the liquid crystal display panel and the liquid crystal display device in accordance with the present invention includes the white sub pixel units disposed in the pixel units. The display color brightness of the liquid crystal display panel is increased, and the display quality of the liquid crystal display panel is enhanced, so as to solve the technical problems that brightness of a displayed image is low and display quality is worse in the conventional liquid crystal display panel and the liquid crystal display device.

For a better understanding of the aforementioned content of the present invention, preferable embodiments are illustrated in accordance with the attached figures for further explanation.

### BRIEF DESCRIPTION OF THE DRAWINGS

FIG. 1 is a structure of a liquid crystal display panel in accordance with a first preferred embodiment of the present invention.

FIG. 2 is a structure of a liquid crystal display panel in accordance with a second preferred embodiment of the present invention.

FIG. 3 is a structure of a liquid crystal display panel in accordance with a third preferred embodiment of the present invention.

FIG. 4 is a structure of a liquid crystal display panel in accordance with a fourth preferred embodiment of the present invention.

### DETAILED DESCRIPTION

The following embodiments are referring to the accompanying drawings for exemplifying specific implementable embodiments of the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

In the drawings, structure-like elements are labeled with like reference numerals.

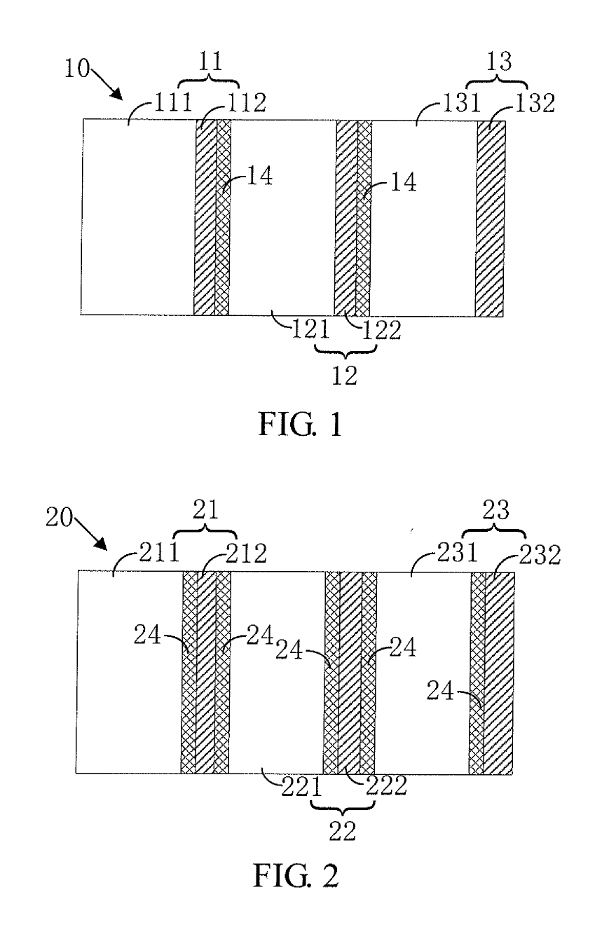

Please refer to FIG. 1. FIG. 1 is a structure of a liquid crystal display panel in accordance with a first preferred embodiment of the present invention. The liquid crystal display panel in accordance with the present preferred embodiment includes data lines (not shown), scan lines (not shown), and pixel units 10 disposed among the data lines and the scan lines.

Each pixel unit 10 includes a plurality of red pixel units 11, a plurality of green pixel units 12, and a plurality of blue pixel units 13. Each red pixel unit 11 includes a red sub pixel unit 111 and a first white sub pixel unit 112 which are driven by a same red pixel electrode. Each green pixel unit 12 includes a green sub pixel unit 121 and a second white sub pixel unit 122 which are driven by a same green pixel electrode. Each blue pixel unit 13 includes a blue sub pixel unit 131 and a third white sub pixel unit 132 which are driven by a same blue pixel electrode.

In the present preferred embodiment, the first white sub pixel unit 112 is disposed at one side of the corresponding red sub pixel unit 111. The second white sub pixel unit 122 is disposed at one side of the corresponding green sub pixel unit 121. The third white sub pixel unit 132 is disposed at one side of the corresponding blue sub pixel unit 131.

A black matrix 14 is disposed between the red pixel unit 11 and the adjacent green pixel unit 12. A black matrix 14 is disposed between the green pixel unit 12 and the adjacent blue pixel unit 13. A black matrix 14 is disposed between the blue pixel unit 13 and the adjacent red pixel unit 11. As such, cross-reference phenomenon between different colors of the pixel units can be avoided.

When the liquid crystal panel in accordance with the present preferred embodiment is utilized, the red sub pixel unit 111 and the first white sub pixel unit 112 are driven by the same red pixel electrode. Accordingly, when a pure red image is displayed, only the red pixel electrode is required to be driven, so that the red sub pixel unit 111 and the first white sub pixel unit 112 are operated. The green sub pixel unit 121, the blue sub pixel unit 131, the second white sub pixel unit 122, and the third white sub pixel unit 132 are not operated. Since increased white light is less than that of a conventional liquid crystal display panel (about one third of the conventional liquid crystal display panel), color saturation of the red image and color brightness of red light can be enhanced.

The green sub pixel unit 121 and the second white sub pixel unit 122 are driven by the same green pixel electrode. Accordingly, when a pure green image is displayed, only the green pixel electrode is required to be driven, so that the green sub pixel unit 121 and the second white sub pixel unit 122 are operated. The red sub pixel unit 111, the blue sub pixel unit 131, the first white sub pixel unit 112, and the third white sub pixel unit 132 are not operated. Since increased white light is less than that of a conventional liquid crystal display panel, color saturation of the green image and color brightness of green light can be enhanced.

The blue sub pixel unit 131 and the third white sub pixel unit 132 are driven by the same blue pixel electrode. Accordingly, when a pure blue image is displayed, only the blue pixel electrode is required to be driven, so that the blue sub pixel unit 131 and the third white sub pixel unit 132 are operated. The red sub pixel unit 111, the green sub pixel unit 121, the first white sub pixel unit 112, and the second white sub pixel unit 122 are not operated. Since increased white light is less than that of a conventional liquid crystal display panel, color saturation of the blue image and color brightness of blue light can be enhanced.

When the liquid crystal display panel in accordance with the present preferred embodiment displays a pure white image, the red sub pixel unit 111, the green sub pixel unit 121, the blue sub pixel unit 131, the first white sub pixel 112, the second white sub pixel unit 122, and the third white sub pixel unit 132 are co-operated. The white image can be displayed with same power and display effect as the conventional liquid crystal display panel,

As such, display processes of the pure color images of the liquid crystal display panel in accordance with the present preferred embodiment are achieved.

Preferably, areas of the red pixel unit 11, the green pixel unit 12, and the blue pixel unit 13 are the same for convenience of manufacturing each pixel unit.

Preferably, areas of the first white sub pixel unit 112 corresponding to the red sub pixel unit 111, the second white sub pixel unit 122 corresponding to the green sub pixel unit 121, and the third white sub pixel unit 132 corresponding to the blue sub pixel unit 131 are the same for convenience of manufacturing each pixel unit.

Preferably, in order to adjust proportions of the red light, the green light, and the blue light reasonably, the areas of the first white sub pixel unit 112 corresponding to the red sub pixel unit 111, the second white sub pixel unit 122 corresponding to the green sub pixel unit 121, and the third white sub pixel unit 132 corresponding to the blue sub pixel unit 131 may be different. When a user wants to decrease the proportion of the red light, the area of the first white sub pixel unit 112 can be disposed to be larger, and the areas of the second white sub pixel unit 122 and the third white sub pixel unit 132 can be disposed to be smaller.

In the liquid crystal display panel in accordance with the present preferred embodiment, the white sub pixel units are disposed in the pixel units. The display color brightness of the liquid crystal display panel is increased, and the display quality of the liquid crystal display panel is enhanced.

Please refer to FIG. 2. FIG. 2 is a structure of a liquid crystal display panel in accordance with a second preferred embodiment of the present invention. The liquid crystal display panel in accordance with the present preferred embodiment includes data lines (not shown), scan lines (not shown), and pixel units 20 disposed among the data lines and the scan lines.

Each pixel unit 20 includes a plurality of red pixel units 21, a plurality of green pixel units 22, and a plurality of blue pixel units 23. Each red pixel unit 21 includes a red sub pixel unit 211 and a first white sub pixel unit 212 which are driven by a same red pixel electrode. Each green pixel unit 22 includes a green sub pixel unit 221 and a second white sub pixel unit 222 which are driven by a same green pixel electrode. Each blue pixel units 23 includes a blue sub pixel unit 231 and a third white sub pixel unit 232 which are driven by a same blue pixel electrode.

In the present preferred embodiment, the first white sub pixel unit 212 is disposed at one side of the corresponding red sub pixel unit 211. The second white sub pixel unit 222 is disposed at one side of the corresponding green sub pixel unit 221. The third white sub pixel unit 232 is disposed at one side of the corresponding blue sub pixel unit 231.

A black matrix 24 is disposed between the red pixel unit 21 and the adjacent green pixel unit 22. A black matrix 24 is disposed between the green pixel unit 22 and the adjacent blue pixel unit 23. A black matrix 14 is disposed between the blue pixel unit 23 and the adjacent red pixel unit 21.

In the liquid crystal display panel in accordance with the present preferred embodiment, a black matrix 24 is disposed between the first white sub pixel unit 212 and the red sub pixel unit 211. A black matrix 24 is disposed between the second white sub pixel unit 222 and the green sub pixel unit 221. A black matrix 24 is disposed between the third white sub pixel unit 232 and the blue sub pixel unit 231. As such, cross-reference phenomenon between each of the white sub pixels and each of the sub pixel units can be avoided, and the display quality of the liquid crystal display panel can be further enhanced.

A specific operating principle of the liquid crystal display panel in accordance with the present preferred embodiment is the same as or similar to that of the liquid crystal display panel in accordance with the first preferred embodiment. Embodiments can refer to related descriptions of the liquid crystal display panel in accordance with the first preferred embodiment.

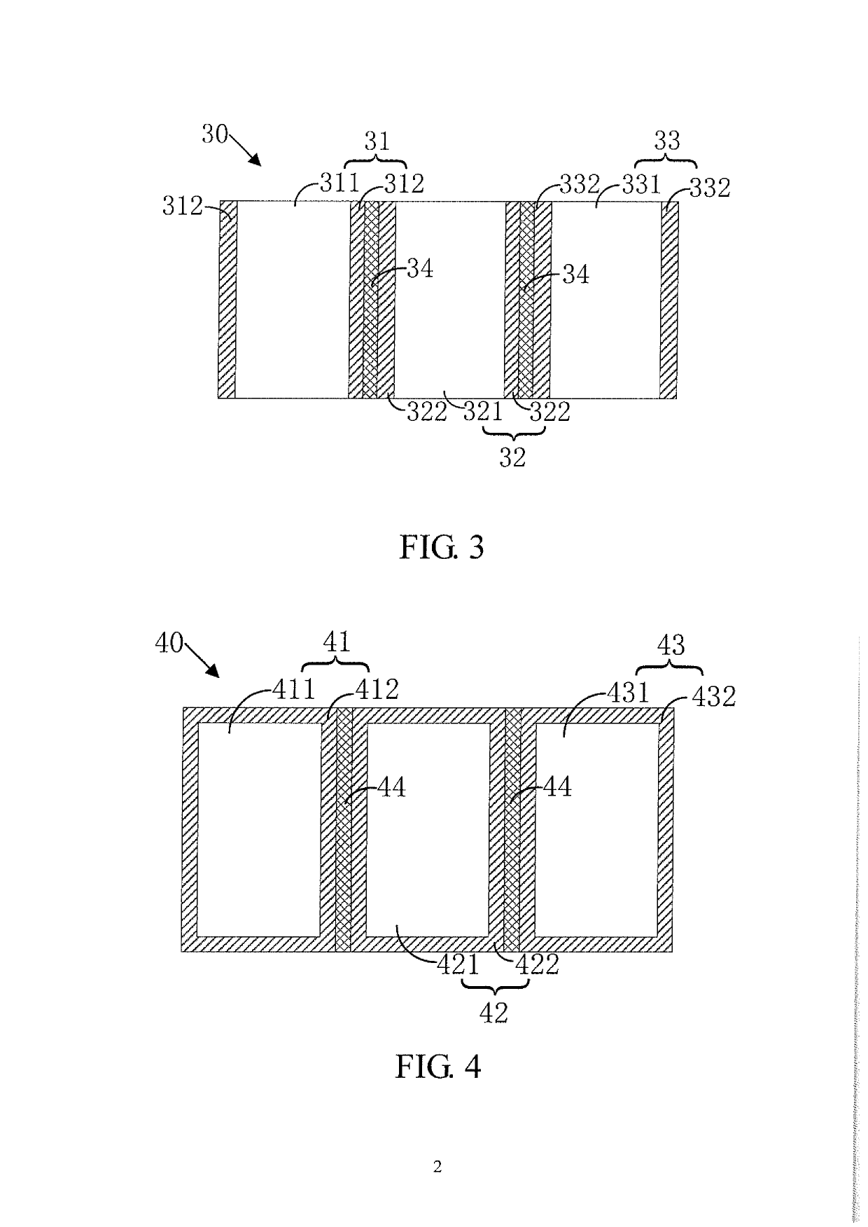

Please refer to FIG. 3. FIG. 3 is a structure of a liquid crystal display panel in accordance with a third preferred embodiment of the present invention. The liquid crystal display panel in accordance with the present preferred embodiment includes data lines (not shown), scan lines (not shown), and pixel units 30 disposed among the data lines and the scan lines.

Each pixel unit 30 includes a plurality of red pixel units 31, a plurality of green pixel units 32, and a plurality of blue pixel units 33. Each red pixel unit 31 includes a red sub pixel unit 311 and first white sub pixel units 312 which are driven by a same red pixel electrode. Each green pixel unit 32 includes a green sub pixel unit 321 and second white sub pixel units 322 which are driven by a same green pixel electrode. Each blue pixel unit 33 includes a blue sub pixel unit 331 and third white sub pixel units 332 which are driven by a same blue pixel electrode.

A black matrix 34 is disposed between the red pixel unit 31 and the adjacent green pixel unit 32. A black matrix 14 is disposed between the green pixel unit 32 and the adjacent blue pixel unit 33. A black matrix 34 is disposed between the blue pixel unit 33 and the adjacent red pixel unit 31.

In the present preferred embodiment, the first white sub pixel units 312 are disposed at two sides of the corresponding red sub pixel unit 311. The second white sub pixel units 322 are disposed at two side of the corresponding green sub pixel unit 321. The third white sub pixel units 332 are disposed at two side of the corresponding blue sub pixel unit 331. As such, when the red pixel unit 31 displays a pure red color, light is more uniform. When the green pixel unit 32 displays a pure green color, light is more uniform. When the blue pixel unit 33 displays a blue red color, light is more uniform.

Preferably, for convenience of manufacturing each pixel unit, areas of the first white sub pixel units 312 corresponding to the red sub pixel unit 311 are the same. Areas of the second white sub pixel units 322 corresponding to the green sub pixel unit 321 are the same. Areas of the third white sub pixel units 332 corresponding to the blue sub pixel unit 331 are the same.

Preferably, in order to adjust proportions of the red light, the green light, and the blue light reasonably, the areas of the first white sub pixel units 312 corresponding to the red sub pixel unit 311, the second white sub pixel units 322 corresponding to the green sub pixel unit 321, and the third white sub pixel units 332 corresponding to the blue sub pixel unit 331 may be different. When the user wants to decrease the proportion of the red light, the areas of the first white sub pixel units 312 can be disposed to be larger, and the areas of the second white sub pixel units 322 and the third white sub pixel units 332 can be disposed to be smaller.

A specific operating principle of the liquid crystal display panel in accordance with the present preferred embodiment is the same as or similar to that of the liquid crystal display panel in accordance with the first preferred embodiment. Embodiments can refer to related descriptions of the liquid crystal display panel in accordance with the first preferred embodiment.

Based on the first preferred embodiment, the white sub pixel units are disposed at the two sides of the corresponding sub pixel unit in the liquid crystal display panel in accordance with the present preferred embodiment, and thus color uniformity of a displayed image is increased.

Please refer to FIG. 4. FIG. 4 is a structure of a liquid crystal display panel in accordance with a fourth preferred embodiment of the present invention. The liquid crystal display panel in accordance with the present preferred embodiment includes data lines (not shown), scan lines (not shown), and pixel units 40 disposed among the data lines and the scan lines.

Each pixel unit 40 includes a plurality of red pixel units 41, a plurality of green pixel units 42, and a plurality of blue pixel units 43. Each red pixel unit 41 includes a red sub pixel unit 411 and first white sub pixel units 412 which are driven by a same red pixel electrode. Each green pixel unit 42 includes a green sub pixel unit 421 and second white sub pixel units 422 which are driven by a same green pixel electrode. Each blue pixel unit 43 includes a blue sub pixel unit 431 and third white sub pixel units 432 which are driven by a same blue pixel electrode.

A black matrix 44 is disposed between the red pixel unit 41 and the adjacent green pixel unit 42. A black matrix 44 is disposed between the green pixel unit 42 and the adjacent blue pixel unit 43. A black matrix 44 is disposed between the blue pixel unit 43 and the adjacent red pixel unit 41.

In the present preferred embodiment, the first white sub pixel units 412 are disposed around the corresponding red sub pixel unit 411. The second white sub pixel units 422 are disposed around the corresponding green sub pixel unit 421. The third white sub pixel units 432 are disposed around the corresponding blue sub pixel unit 431. As such, based on the third preferred embodiment, when the red pixel unit 41 displays a pure red color, light is more uniform. When the green pixel unit 42 displays a pure green color, light is more uniform. When the blue pixel unit 43 displays a blue red color, light is more uniform.

Preferably, for convenience of manufacturing each pixel unit, areas of the first white sub pixel units 412 corresponding to the red sub pixel unit 411 are the same. Areas of the second white sub pixel units 422 corresponding to the green sub pixel unit 421 are the same. Areas of the third white sub pixel units 432 corresponding to the blue sub pixel unit 431 are the same.

Preferably, in order to adjust proportions of the red light, the green light, and the blue light reasonably, the areas of the first white sub pixel units 412 corresponding to the red sub pixel unit 411, the second white sub pixel units 422 corresponding to the green sub pixel unit 421, and the third white sub pixel units 432 corresponding to the blue sub pixel unit 431 may be different. When the user wants to decrease the proportion of the red light, the areas of the first white sub pixel units 412 can be disposed to be larger, and the areas of the second white sub pixel units 422 and the third white sub pixel units 432 can be disposed to be smaller.

A specific operating principle of the liquid crystal display panel in accordance with the present preferred embodiment is the same as or similar to that of the liquid crystal display panel in accordance with the first preferred embodiment. Embodiments can refer to related descriptions of the liquid crystal display panel in accordance with the first preferred embodiment.

Based on the third preferred embodiment, the white sub pixel units are disposed around the corresponding sub pixel unit in the liquid crystal display panel in accordance with the present preferred embodiment, and thus color uniformity of a displayed image is increased.

The present invention further provides a liquid crystal display device which includes a liquid crystal display panel and a corresponding backlight source. The liquid crystal display panel in accordance with the present preferred embodiment includes data lines (not shown), scan lines (not shown), and pixel units disposed among the data lines and the scan lines.

Each pixel unit includes a plurality of red pixel units, a plurality of green pixel units, and a plurality of blue pixel units. Each red pixel unit includes a red sub pixel unit and at least one first white sub pixel unit which are driven by a same red pixel electrode. Each green pixel unit includes a green sub pixel unit and at least one second white sub pixel unit which are driven by a same green pixel electrode. Each blue pixel unit includes a blue sub pixel unit and at least one third white sub pixel unit which are driven by a same blue pixel electrode.

Preferably, the first white sub pixel unit is disposed at one side of the corresponding red sub pixel unit. The second white sub pixel unit is disposed at one side of the corresponding green sub pixel unit. The third white sub pixel unit is disposed at one side of the corresponding blue sub pixel unit.

Preferably, a black matrix is disposed between the first white sub pixel unit and the red sub pixel unit. A black matrix is disposed between the second white sub pixel unit and the green sub pixel unit. A black matrix is disposed between the third white sub pixel unit and the blue sub pixel unit.

Preferably, the first white sub pixel units are disposed at two sides of the corresponding red sub pixel unit. The second white sub pixel units are disposed at two side of the corresponding green sub pixel unit. The third white sub pixel units are disposed at two side of the corresponding blue sub pixel unit.

Preferably, areas of the first white sub pixel units at the two sides of the red sub pixel unit are the same. Areas of the second white sub pixel units at the two sides of the green sub pixel unit are the same. Areas of the third white sub pixel units at the two sides of the blue sub pixel unit are the same.

Preferably, the first white sub pixel units are disposed around the corresponding red sub pixel unit. The second white sub pixel units are disposed around the corresponding green sub pixel unit. The third white sub pixel units are disposed around the corresponding blue sub pixel unit.

Preferably, a black matrix is disposed between the red pixel unit and the adjacent green pixel unit. A black matrix is disposed between the green pixel unit and the adjacent blue pixel unit. A black matrix is disposed between the blue pixel unit and the adjacent red pixel unit.

Preferably, areas of the red pixel unit, the green pixel unit, and the blue sub pixel unit are the same.

Preferably, the areas of at least two of the first white sub pixel unit, the second white sub pixel unit, and the third white sub pixel unit are different.

A specific operating principle of the liquid crystal display device in accordance with the present invention is the same as or similar to any one of the liquid crystal display panels in accordance with the preferred embodiments. Embodiments can refer to related descriptions of the liquid crystal display panels in accordance with the preferred embodiments.

In the liquid crystal display panel and the liquid crystal display device in accordance with the present invention, the white sub pixel units are disposed in the pixel units. The display color brightness of the liquid crystal display panel is increased, and the display quality of the liquid crystal display panel is enhanced, so as to solve the technical problems that brightness of a displayed image is low and display quality is worse in the conventional liquid crystal display panel and the liquid crystal display device.

As is understood by a person skilled in the art, the foregoing preferred embodiments of the present invention are illustrative rather than limiting of the present invention. It is intended that they cover various modifications and similar arrangements be included within the spirit and scope of the present invention, the scope of which should be accorded the broadest interpretation so as to encompass all such modifications and similar structures.

What is claimed is:

1. A liquid crystal display panel, comprising data lines, scan lines, and pixel units disposed among the data lines and the scan lines,
wherein each of the pixel units comprises:
a plurality of red pixel units each comprising a red sub pixel unit and at least one first white sub pixel unit which are driven by a same red pixel electrode;
a plurality of green pixel units each comprising a green sub pixel unit and at least one second white sub pixel unit which are driven by a same green pixel electrode; and
a plurality of blue pixel units each comprising a blue sub pixel unit and at least one third white sub pixel unit which are driven by a same blue pixel electrode,
wherein a black matrix is disposed between the red pixel unit and an adjacent green pixel unit; a black matrix is disposed between the green pixel unit and an adjacent blue pixel unit; a black matrix is disposed between the blue pixel unit and an adjacent red pixel unit;
an area of the red pixel unit, an area of the green pixel unit, and an area of the blue pixel unit are the same;
areas of at least two of the first white sub pixel unit, the second white sub pixel unit, and the third white sub pixel unit are different.

2. The liquid crystal display panel of claim 1, wherein the first white sub pixel unit is disposed at one side of a corresponding red sub pixel unit;
the second white sub pixel unit is disposed at one side of a corresponding green sub pixel unit;
the third white sub pixel unit is disposed at one side of a corresponding blue sub pixel unit.

3. The liquid crystal display panel of claim 2, wherein a black matrix is disposed between the first white sub pixel unit and the red sub pixel unit;
a black matrix is disposed between the second white sub pixel unit and the green sub pixel unit;
a black matrix is disposed between the third white sub pixel unit and the blue sub pixel unit.

4. The liquid crystal display panel of claim 1, wherein the first white sub pixel units are disposed at two sides of a corresponding red sub pixel unit;
the second white sub pixel units are disposed at two side of a corresponding green sub pixel unit;
the third white sub pixel units are disposed at two side of a corresponding blue sub pixel unit.

5. The liquid crystal display panel of claim 4, wherein areas of the first white sub pixel units at the two sides of the red sub pixel unit are the same;
areas of the second white sub pixel units at the two sides of the green sub pixel unit are the same;
areas of the third white sub pixel units at the two sides of the blue sub pixel unit are the same.

6. The liquid crystal display panel of claim 1, wherein the first white sub pixel units are disposed around a corresponding red sub pixel unit;
the second white sub pixel units are disposed around a corresponding green sub pixel unit;
the third white sub pixel units are disposed around a corresponding blue sub pixel unit.

7. A liquid crystal display panel, comprising data lines, scan lines, and pixel units disposed among the data lines and the scan lines,
wherein each of the pixel units comprises:
a plurality of red pixel units each comprising a red sub pixel unit and at least one first white sub pixel unit which are driven by a same red pixel electrode;
a plurality of green pixel units each comprising a green sub pixel unit and at least one second white sub pixel unit which are driven by a same green pixel electrode; and
a plurality of blue pixel units each comprising a blue sub pixel unit and at least one third white sub pixel unit which are driven by a same blue pixel electrode.

8. The liquid crystal display panel of claim 7, wherein the first white sub pixel unit is disposed at one side of a corresponding red sub pixel unit;
the second white sub pixel unit is disposed at one side of a corresponding green sub pixel unit;
the third white sub pixel unit is disposed at one side of a corresponding blue sub pixel unit.

9. The liquid crystal display panel of claim 8, wherein a black matrix is disposed between the first white sub pixel unit and the red sub pixel unit;
a black matrix is disposed between the second white sub pixel unit and the green sub pixel unit;
a black matrix is disposed between the third white sub pixel unit and the blue sub pixel unit.

10. The liquid crystal display panel of claim 7, wherein the first white sub pixel units are disposed at two sides of a corresponding red sub pixel unit;
the second white sub pixel units are disposed at two side of a corresponding green sub pixel unit;
the third white sub pixel units are disposed at two side of a corresponding blue sub pixel unit.

11. The liquid crystal display panel of claim 10, wherein areas of the first white sub pixel units at the two sides of the red sub pixel unit are the same;
areas of the second white sub pixel units at the two sides of the green sub pixel unit are the same;
areas of the third white sub pixel units at the two sides of the blue sub pixel unit are the same.

12. The liquid crystal display panel of claim 7, wherein the first white sub pixel units are disposed around a corresponding red sub pixel unit;
the second white sub pixel units are disposed around a corresponding green sub pixel unit;
the third white sub pixel units are disposed around a corresponding blue sub pixel unit.

13. The liquid crystal display panel of claim 7, wherein a black matrix is disposed between the red pixel unit and an adjacent green pixel unit; a black matrix is disposed between the green pixel unit and an adjacent blue pixel unit; a black matrix is disposed between the blue pixel unit and an adjacent red pixel unit.

14. The liquid crystal display panel of claim 7, wherein an area of the red pixel unit, an area of the green pixel unit, and an area of the blue pixel unit are the same.

15. The liquid crystal display panel of claim 7, wherein areas of at least two of the first white sub pixel unit, the second white sub pixel unit, and the third white sub pixel unit are different.

16. A liquid crystal display device, comprising a liquid crystal display panel and a backlight module, the liquid crystal display panel comprising data lines, scan lines, and pixel units disposed among the data lines and the scan lines,
wherein each of the pixel units comprises:
a plurality of red pixel units each comprising a red sub pixel unit and at least one first white sub pixel unit which are driven by a same red pixel electrode;
a plurality of green pixel units each comprising a green sub pixel unit and at least one second white sub pixel unit which are driven by a same green pixel electrode; and
a plurality of blue pixel units each comprising a blue sub pixel unit and at least one third white sub pixel unit which are driven by a same blue pixel electrode.

17. The liquid crystal display device of claim 16, wherein the first white sub pixel unit is disposed at one side of a corresponding red sub pixel unit;
the second white sub pixel unit is disposed at one side of a corresponding green sub pixel unit;
the third white sub pixel unit is disposed at one side of a corresponding blue sub pixel unit.

18. The liquid crystal display device of claim 17, wherein a black matrix is disposed between the first white sub pixel unit and the red sub pixel unit;
a black matrix is disposed between the second white sub pixel unit and the green sub pixel unit;
a black matrix is disposed between the third white sub pixel unit and the blue sub pixel unit.

19. The liquid crystal display device of claim 16, wherein the first white sub pixel units are disposed at two sides of a corresponding red sub pixel unit;
the second white sub pixel units are disposed at two side of a corresponding green sub pixel unit;
the third white sub pixel units are disposed at two side of a corresponding blue sub pixel unit.

20. The liquid crystal display device of claim 16, wherein the first white sub pixel units are disposed around a corresponding red sub pixel unit;
the second white sub pixel units are disposed around a corresponding green sub pixel unit;
the third white sub pixel units are disposed around a corresponding blue sub pixel unit.
